(19) United States
(12) Patent Application Publication
(10) Pub. No.: US 2006/0260432 A1
(43) Pub. Date: Nov. 23, 2006

(54) HANDLEBAR ADJUSTING DEVICE FOR A BICYCLE

(76) Inventor: Jung-Yu Hsu, Tainan (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/423,656

(22) Filed: Jun. 12, 2006

Related U.S. Application Data
(63) Continuation-in-part of application No. 10/724,334, filed on Nov. 25, 2003, now abandoned.

(51) Int. Cl. B62K 21/16

(52) U.S. Cl. 74/551.3

(57) ABSTRACT

A handlebar adjusting device for a bicycle has an erecting rod, a connecting piece, a tube fastening piece and a retractable element. The erecting rod has a first pivotal block and a second pivotal block mounted thereon. The connecting piece has a one end defined with a recess for engaging the first pivotal block and has another end having a third pivotal block. The bar-fastening piece is attached to the connecting piece. The retractable element pivotally connects between the second and third pivotal blocks on the erecting rod and is composed of a fourth pivotal block, outer tube, movable piston, hydraulic valve assembly, piston shaft, compressing device, driving shaft, anti-leaking ring and fifth pivotal block. By retracting the piston shaft of the retractable element, angles between the connecting piece and the erecting rod are adjustable to further adjust heights and to provide anti-vibration efficiency to the handlebar.

### CROSS REFERENCE

This is a Continuation In Part application of U.S. application Ser. No. 10/724,334.

### BACKGROUND OF THE INVENTION

1. Field of the Invention

The present invention relates to a handlebar adjusting device for a bicycle, and more particularly to a handlebar adjusting device that has a retractable element to enable angle adjustment to have anti-vibration efficiency.

2. Description of Related Art

Conventional handlebars as described in US patents in numbers of U.S. Pat. Nos. 5,285,697, 5,186,074, 5,220,851, 5,678,457 and 5,467,665 either do not have anti-vibration efficiency or do not have height-adjusting capability. Therefore, the bicycle manufacturers still dedicate to develop a modified handlebar device that possesses both anti-vibration efficiency and height-adjusting capability.

The present invention has arisen to mitigate or obviate the disadvantages of the conventional handlebars for bicycles.

### SUMMARY OF THE INVENTION

The main objective of the present invention is to provide a handlebar adjusting device that has a retractable element with a piston shaft extending or retracting to adjust height of a handlebar and to provide an anti-vibration efficiency to the handlebar.

To achieve the foregoing main objective, the handlebar adjusting device for a bicycle comprises:

an erecting rod with a first pivotal block and a second pivotal block;

a connecting piece pivotally connected to the erecting rod and having one end formed with a recess for pivotally receiving the first pivotal block and another end with a top face and a bottom face respectively formed with a first bar recess on the top face and a third pivotal block defined on the bottom face;

a bar-fastening piece mounted on the connecting piece over the first bar recess;

a retractable element pivotally connected between the erecting block and the connecting piece, wherein the retractable element comprises:

an outer tube having one end formed with a fourth pivotal block pivotally engaged the second pivotal block on the erecting rod and another end formed with a fifth pivotal block pivotally engaged the third pivotal block on the connecting piece;

a movable piston received inside the outer tube and dividing interior of the outer tube into a gas chamber and a liquid chamber;

a hydraulic valve assembly received inside the liquid chamber and having a hydraulic piston radially and movably received inside the liquid chamber, a valve shaft with a neck movably engaged the hydraulic piston and axially extending toward the fifth pivotal block, a protrusion portion slidably formed around the valve shaft and a liquid hole defined between the protrusion portion and the hydraulic piston to align with the neck when the hydraulic valve assembly is closed;

a piston shaft being a tube having inner end receiving the protrusion portion, a spring chamber adjacent the inner end, an outer end axially defined with a shaft channel that communicates with the spring chamber, a driving shaft movably received inside the shaft channel, a compressing device received inside the spring chamber and clamped between the driving shaft and protrusion portion, an anti-leaking ring mounted on a joint between the outer tube and the piston shaft, and a fifth pivotal block mounted on the piston shaft; and

a lever pivotally mounted on the fifth pivotal block and having a bias portion operationally pushing the driving shaft to compress the compressing device and then move the valve shaft so that the neck moves slightly inward to perform a channel that opens the hydraulic valve assembly.

By arranging the retractable element and the lever between the erecting rod and the connecting piece, the handlebar is adjustable in height and anti-vibration efficiency.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a handlebar adjusting device in accordance with the present invention;

FIG. 2 is a perspective view of the handlebar adjusting device of FIG. 1 in combination, wherein the handlebar adjusting device is at the lowest position;

FIG. 3 is a cross-sectional side view of the handlebar adjusting device in accordance with FIG. 2;

FIG. 4 is a cross-sectional side view of a retractable element in the handlebar adjusting device in accordance with FIG. 2;

FIG. 5 is an operational cross-sectional side view showing an actuation of a piston shaft in the handlebar adjusting device;

FIG. 6 is an operational cross-sectional side view showing an angle-adjusting movement of the handlebar adjusting device;

FIG. 7 is a cross-sectional side view of the retractable element in the handlebar adjusting device that is at the highest position;

FIG. 8 is a perspective view of the handlebar adjusting device that is at the highest position; and

FIG. 9 is a cross-sectional side view of the handlebar adjusting device in accordance with FIG. 8.

### DETAILED DESCRIPTION OF THE PREFERRED EMBODIMENT

A handlebar adjusting device for a bicycle in accordance with the present invention comprises an erecting rod, a connecting piece, a tube fastening piece and a retractable element. The erecting rod has a first pivotal block and a second pivotal block mounted on an upper end thereof. The connecting piece has a one end defined with a recess for engaging the first pivotal block and has another end having a first bar recess and a third pivotal block. The bar-fastening piece is attached to a top end of the first bar recess on the connecting piece. The retractable element pivotally connects between the second and third pivotal blocks on the erecting rod and is composed of a fourth pivotal block, outer tube, movable piston, hydraulic valve assembly, piston shaft, compressing device, driving shaft, anti-leaking ring and fifth pivotal block. By retracting or extending the piston shaft of the retractable element, angles between the connecting piece and the erecting rod are adjustable to further adjust heights of the handlebar and to provide anti-vibration efficiency to the handlebar.

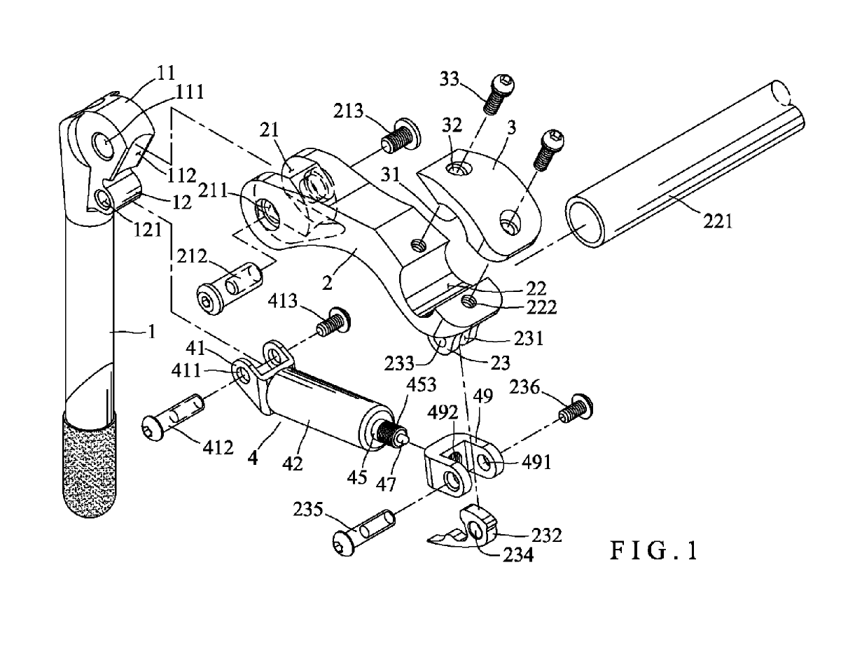

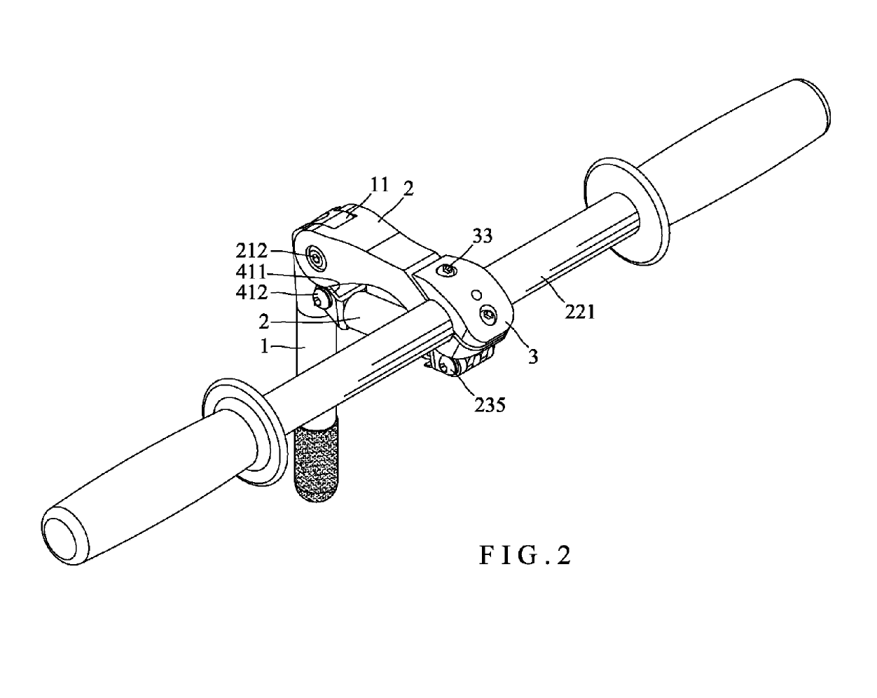

With reference to FIGS. 1 and 2, a handlebar adjusting device in accordance with the present invention adapts to combine with a handlebar 221 and comprises an erecting rod 1, a connecting piece 2, a bar-fastening piece 3 and a retractable element 4.

The erecting rod 1 has an upper end and a first pivotal block 11 and a second pivotal block 12 mounted on the upper end. The two pivotal blocks 11, 12 respectively have a first through hole 111 and a second through hole 121 defined at respective centers. Moreover, the first pivotal block 11 has a curved cutout 112 defined at an outer periphery facing the connecting piece 2.

The connecting piece 2 pivotally connects to the erecting rod 1 and has two ends. One end of the connecting piece 2 has a recess 21 for engaging the first pivotal block 11 on the erecting rod 1. Another end of the connecting piece 2 has a top face, a bottom face, a first bar recess 22 transversally defined on the top face and a third pivotal block 23 formed on the bottom face. Two sidewalls of the recess 21 each have a third through hole 211 that aligns with the first through hole 111 on the first pivotal block 11 so that a first pivotal shaft 212 penetrates therethrough and combines with a first screw 213 to pivotally combine the first pivotal block 11 and the connecting piece 2 together. The first bar recess 22 engages a middle portion of the handlebar 221. Two threaded holes 222 are defined on the top face of the connecting piece 2 at two opposite side of the first bar recess 22 respectively. The third pivotal block 23 has a middle recess 231 engaged the lever 232. The third pivotal block 23 and the lever 232 have a fourth through hole 233 and a fifth through hole 234 defined at centers respectively and aligned with each other to allow a second pivotal shaft 235 penetrating therethrough to engage with a second screw 236 for combination. Moreover, the lever 232 has a bias portion to operationally push the retractable element 4.

The bar-fastening piece 3 is detachably mounted on the connecting piece 2 over the first bar recess 22 and has a second bar recess 31 corresponding to the first bar recess 22. Two sixth through holes 32 are defined in the bar-fastening piece 3 and respectively align with the threaded holes 222 beside the first bar recess 22 so that two third screws 33 respectively penetrate the sixth through holes 32 to secure with the threaded holes 222.

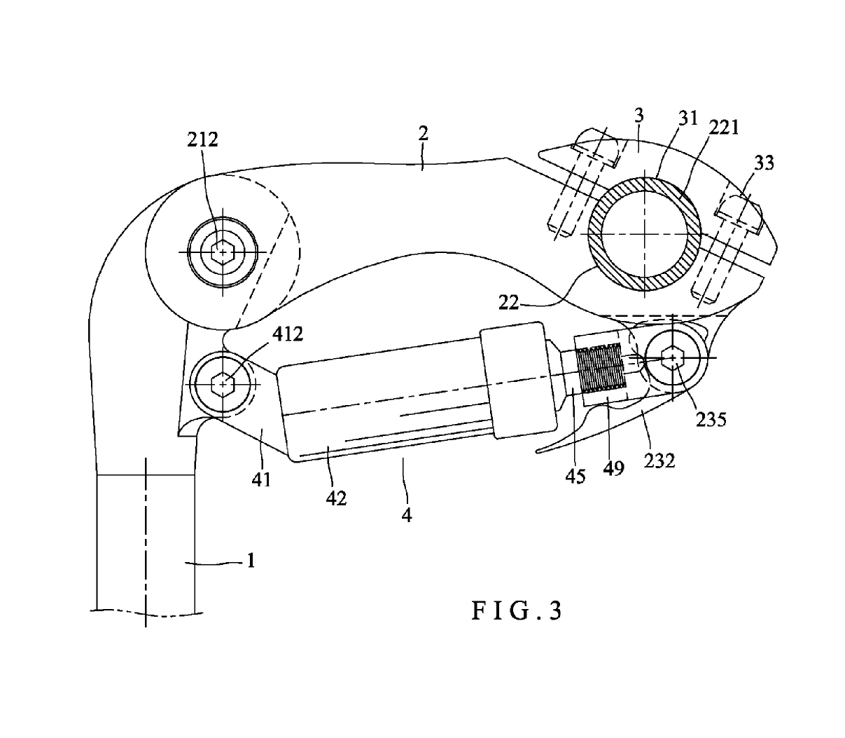

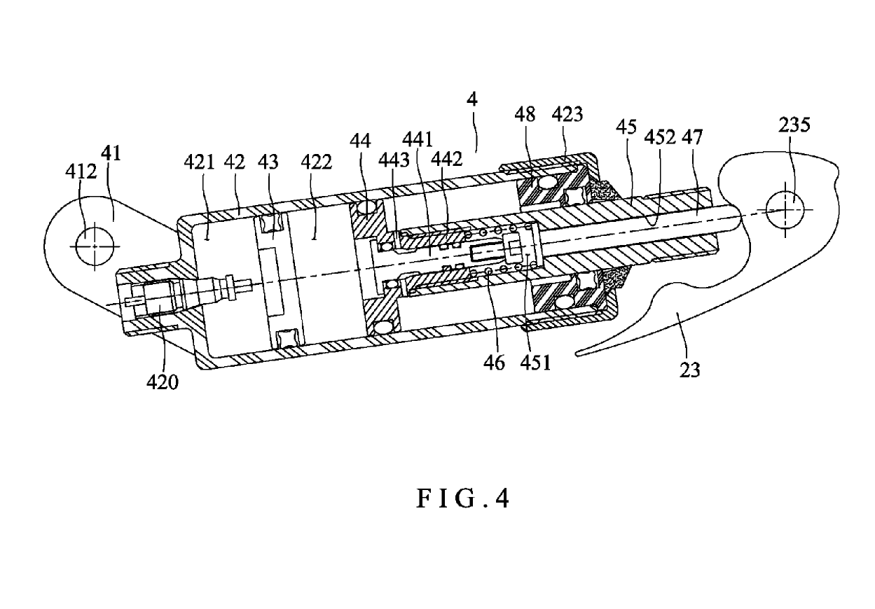

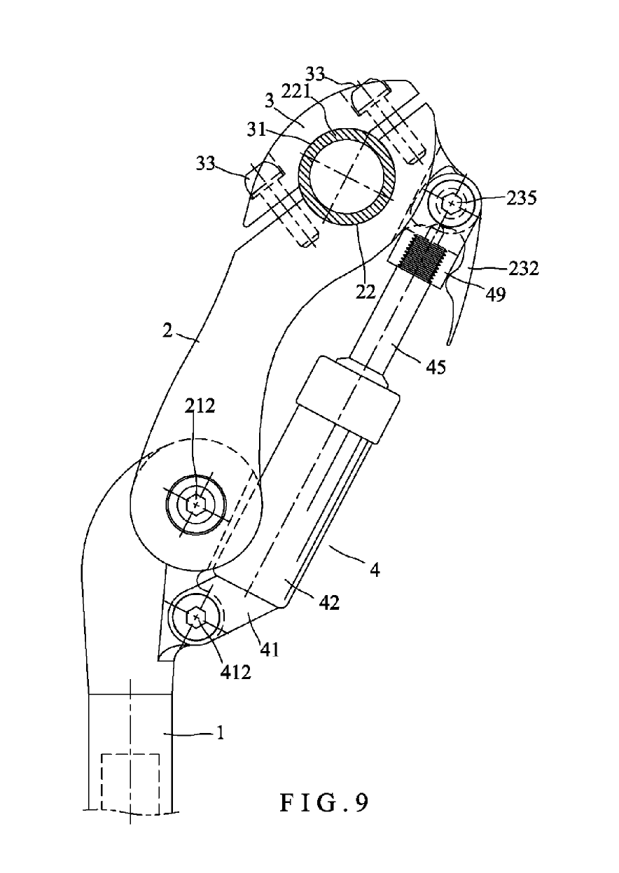

The retractable element 4 extends between the second pivotal block 12 on the erecting rod 1 and the third pivotal block 23 on the connecting piece 2 as shown in FIGS. 3 and 9. The retractable element 4 comprises a fourth pivotal block 21, an outer tube 42, a movable piston, a hydraulic valve assembly 44, a piston shaft 45, a compressing device 46, a driving shaft 47, an anti-leaking ring 48 and a fifth pivotal block 49 as shown in FIG. 4. The fourth pivotal block 41 engages the second pivotal block 12 on the erecting rod 1 and has two sidewalls each with a seventh through hole 411 that aligns with the second though hole 121 on the second pivotal block 12 to allow a third pivotal shaft 412 penetrating therethrough and securing with a fourth screw 413. The outer tube 42 has an inner space divided into a high-pressure gas chamber 421 and liquid chamber 422 by the movable piston 43. Two ends of the outer tube 42 are respectively combined with the fourth pivotal block 41 and a sealing ring 423. The gas chamber 421 has a gas valve 420 attached at an axial center of one corresponding end of the outer tube 42 to allow gas injecting into the gas chamber 421 for adjusting pressure. The hydraulic valve assembly is received inside the liquid chamber 422 and has a hydraulic piston 44, a valve shaft 441 movably engaged the hydraulic piston 44 and axially extending toward the fifth pivotal block 49, a protrusion portion 442 slidably formed around the valve shaft 441, and a liquid hole 443 defined between the protrusion portion 442 and the hydraulic piston 44. Particularly, the valve shaft 441 has a neck (not numbered) aligned with the liquid hole 443 when the hydraulic valve assembly is not actuated.

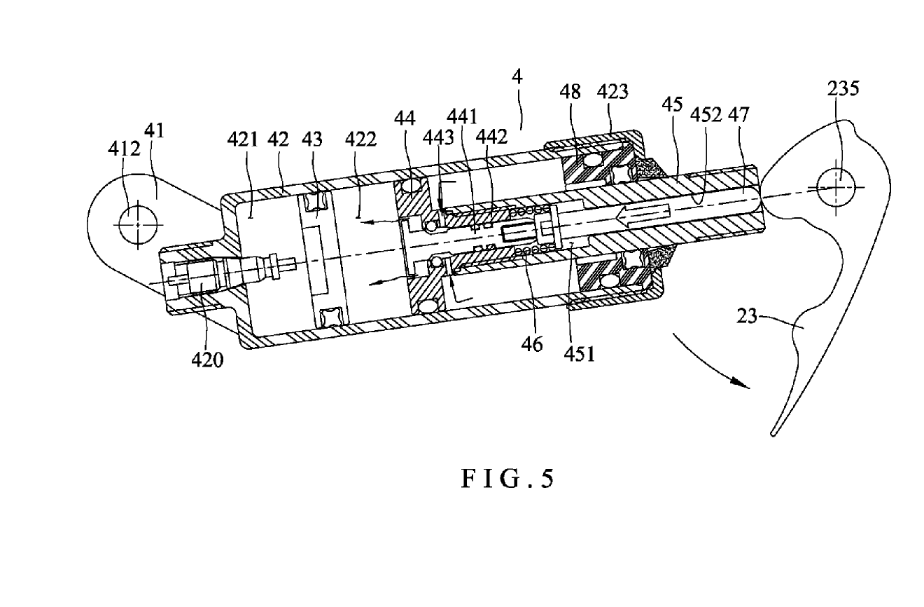

The piston shaft 45 is a tube and has an outer end, an inner end accommodating the protrusion portion 442, a spring chamber 451 adjacent the inner end receiving the compressing device 46 inside, and a shaft channel 452 axially defined in the outer end and communicating with the spring chamber 451. Moreover, the outer end of the piston shaft 451 further has a thread 453 defined on its periphery to engage the fifth pivotal block 49. The driving shaft 47 is movably received inside the shaft channel 452 of the piston shaft 45 and pushed to protrude the piston shaft 45 by extension of the compressing device 46 (i.e. a spring as shown in FIGS. 4 and 5). The anti-leaking ring 48 is clamped between the outer tube 42 and the piston shaft 45 to block the liquid chamber 422 and the sealing ring 423 is further mounted at a joint between the outer tube 42 and the piston shaft 45 to provide an extra anti-leaking efficiency to the hydraulic valve assembly.

The fifth pivotal block 49 as shown in FIG. 1 is rotatably combined with the third pivotal block 23 on the connecting element and has two sidewalls each having an eighth through hole 491 that aligns with the fourth through hole 233 on the third pivotal block 23 to allow the second pivotal shaft 235 penetrating therethrough and engaging the second screw 236 for combination. Moreover, the fifth pivotal block 49 further has a threaded hole 492 defined in a middle section between the two sidewalls to engage the thread 452 on the periphery of the piston shaft 45.

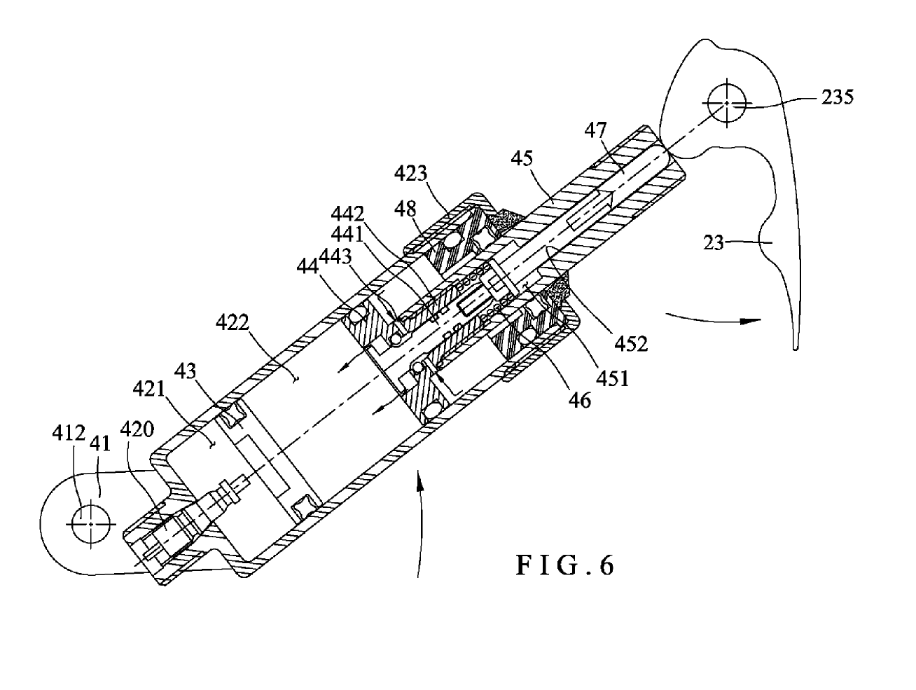

As shown in FIGS. 5 and 6, when a user adjusts the height of the handlebar 221, the lever 232 is pulled outward to make its inner end pressing the driving shaft 47 to move inward. Thereby, the driving shaft 47 further pushes the compressing device 46 and the valve shaft 441 to move toward to the movable piston 43 so that the neck of the valve shaft 441 moves to an entrance of the hydraulic piston 44 to perform a channel communicating between the liquid hole 443 and the liquid chamber 422 and thus the liquid hole 443 of the hydraulic valve assembly is opened. Therefore, the retractably element 2 is adjustable by lifting or lowering the handlebar 221.

When the handlebar 221 is lowered, the liquid in the liquid chamber 422 flows into a front chamber defined between the outer tube 42 and the piston shaft 45 so that the hydraulic piston 44 with the piston shaft 45 slowly moves toward the movable piston 43 to pull the piston shaft 45 inward. When the piston shaft 45 retracts more, angles between the connecting piece 2 and the erecting rod 1 are smaller as shown in FIGS. 2 and 3 so that the height of the handlebar is lower.

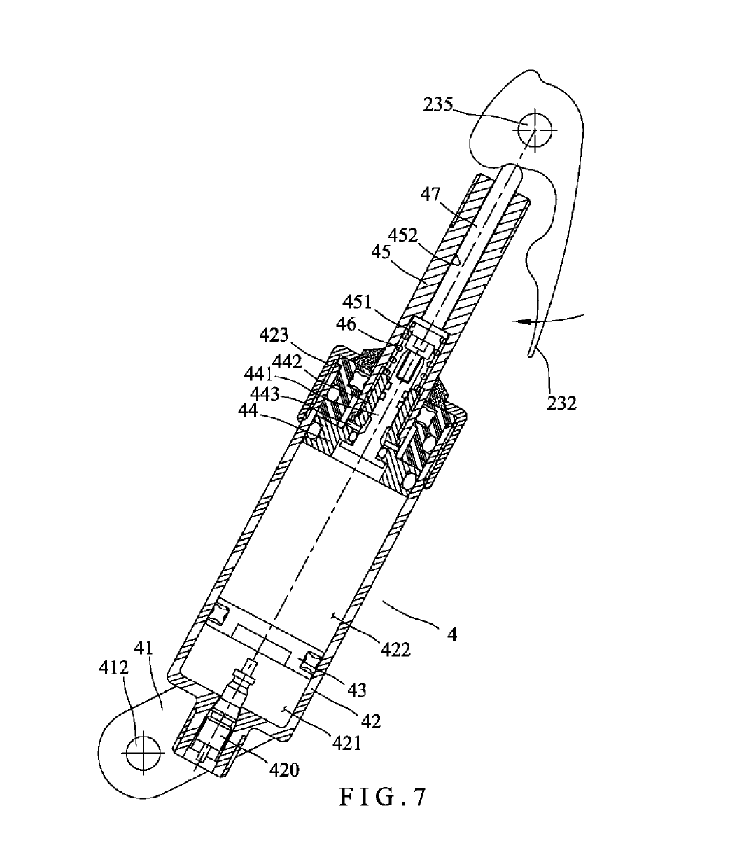

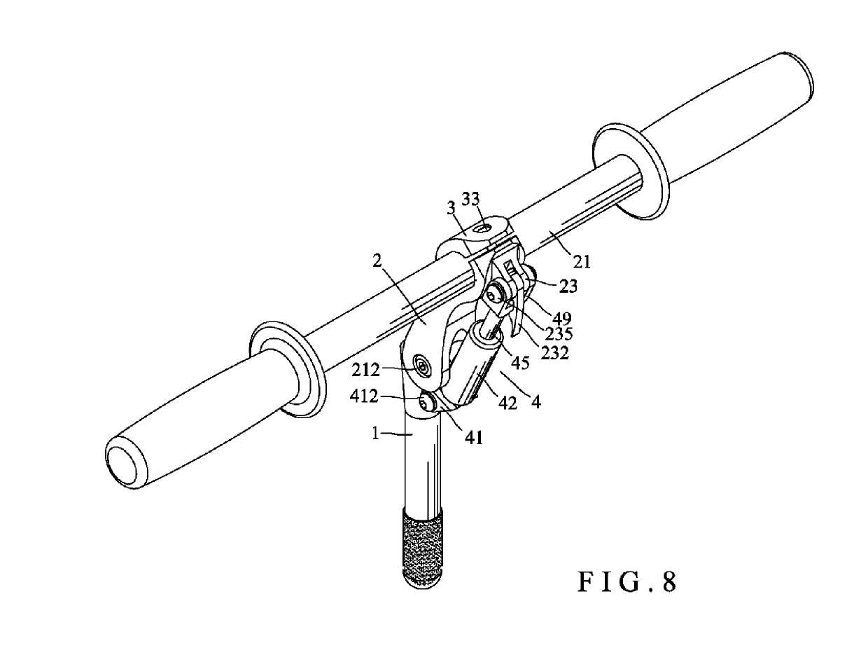

On the contrary, when the handlebar 221 is lifted, the liquid flows from the front chamber back to the liquid chamber 422 so that the hydraulic piston 44 with the piston shaft 45 slowly moves outward from the movable piston 43 to push the piston shaft 45 outward. When the piston shaft 45 extends more, angles between the connecting piece 2 and the erecting rod 1 are larger as shown in FIGS. 7, 8 and 9 so that the height of the handlebar is higher.

When the handlebar 221 is lifted to a highest position as shown in FIG. 9, the lever 232 is rotated again to release the pressing of the driving shaft 47. Then, the driving shaft 47 is pushed outward by the extension of the compressing device 46 and the valve shaft 441 is moved outward block the entrance of the hydraulic piston 44 so that the liquid hole 443 of the hydraulic valve assembly is closed again. When the user rides the bicycle on an uneven road, the handlebar 221 vibrates easily. In this situation, the retractable element 4 provides an anti-vibration efficiency to the handlebar 221. Because the movable piston 43 dividing the high-pressure gas chamber 421 and the liquid chamber 422 is kept balanced by the pressure in the chambers 421, 422, however, the movable piston 43 is moved according to pressure differences caused by the vibration to compensate the vibration force and to provide the damping efficiency. In other words, when the hydraulic valve assembly is unitedly pushed inward by the vibration force, the liquid chamber 422 is compressed to push the movable piston 43 but the high-pressure gas chamber 421 provides a reverse force to push the hydraulic valve assembly back. Therefore, the movable piston 43 automatically balances the pressure difference caused by the vibration and thus provides the anti-vibration efficiency.

According to above description, the handlebar adjusting device for a bicycle in the present invention has the following advantages:

1. The handlebar adjusting device in the present invention possesses both the height-adjusting efficiency and the anti-vibration capability so that the handlebar adjusting device has a novel feature that is not shown in the conventional ones.

2. Operation of the handlebar adjusting device is simply controlled by pushing the lever and adjusting the handlebar 221. Therefore, adjustment of the handlebar 221 by this handlebar adjusting device is quick and convenient.

Although the invention has been explained in relation to its preferred embodiment, it is to be understood that many other possible modifications and variations can be made without departing from the spirit and scope of the invention as hereinafter claimed.

What is claimed is:

1. A handlebar adjusting device comprising:
an erecting rod with a first pivotal block and a second pivotal block;
a connecting piece pivotally connected to the erecting rod and having one end formed with a recess for pivotally receiving the first pivotal block and another end with a top face and a bottom face respectively formed with a first bar recess on the top face and a third pivotal block defined on the bottom face;
a bar-fastening piece mounted on the connecting piece over the first bar recess;
a retractable element pivotally connected between the erecting block and the connecting piece, wherein the retractable element comprises:
an outer tube having one end formed with a fourth pivotal block pivotally engaged the second pivotal block on the erecting rod and another end formed with a fifth pivotal block pivotally engaged the third pivotal block on the connecting piece;
a movable piston received inside the outer tube and dividing interior of the outer tube into a gas chamber and a liquid chamber;
a hydraulic valve assembly received inside the liquid chamber and having a hydraulic piston radially and movably received inside the liquid chamber, a valve shaft with a neck movably engaged the hydraulic piston and axially extending toward the fifth pivotal block, a protrusion portion slidably formed around the valve shaft and a liquid hole defined between the protrusion portion and the hydraulic piston to align with the neck when the hydraulic valve assembly is closed;
a piston shaft being a tube having inner end receiving the protrusion portion, a spring chamber adjacent the inner end, an outer end axially defined with a shaft channel that communicates with the spring chamber, a driving shaft movably received inside the shaft channel, a compressing device received inside the spring chamber and clamped between the driving shaft and protrusion portion, an anti-leaking ring mounted on a joint between the outer tube and the piston shaft, and a fifth pivotal block mounted on the piston shaft; and
a lever pivotally mounted on the fifth pivotal block and having a bias portion operationally pushing the driving shaft to compress the compressing device and then move the valve shaft so that the neck moves slightly inward to perform a channel that opens the hydraulic valve assembly.

2. The handlebar adjusting device as claimed in claim 1, wherein the first pivotal block and the second pivotal block on the erecting rod have a first through hole and a second through hole respectively;
the first pivotal block further has an outer periphery and a curved cutout defined at the outer periphery.

3. The handlebar adjusting device as claimed in claim 2, wherein two sidewalls of the recess on the connecting piece each have a third through hole that aligns with the first through hole on the first pivotal block so that a first pivotal shaft 212 penetrates therethrough and combines with a first screw to pivotally combine the first pivotal block and the connecting piece;
the first bar recess adapts to engage the handlebar and has two threaded holes defined on the top face of the connecting piece at two opposite side of the first bar recess respectively;
the third pivotal block on the connecting piece has a middle recess pivotally engaged the lever, wherein the third pivotal block and the lever have a fourth through hole and a fifth through hole defined at centers respectively and aligned with each other to allow a second pivotal shaft penetrating therethrough to engage with a second screw for combination.

4. The handlebar adjusting device as claimed in claim 3, wherein the bar-fastening piece has a second bar recess corresponding to the first bar recess on the connecting piece and two sixth through holes respectively aligning with the threaded holes beside the first bar recess on the connecting piece so that two third screws respectively penetrate the sixth through holes to secure with the threaded holes.

5. The handlebar adjusting device as claimed in claim 4, wherein two sidewalls of the fourth pivotal block each have a seventh through hole that aligns with the second though hole on the second pivotal block to allow a third pivotal shaft penetrating therethrough and securing with a fourth screw;
a sealing ring is mounted at a joint between the outer tube and the piston shaft to provide an anti-leaking efficiency to the hydraulic valve assembly;
an anti-leaking ring is clamped between the outer tube and the piston shaft to block the liquid chamber;
the outer tube further has a gas valve formed thereon to communicate with the gas chamber for adjusting pressure;
the outer end of the piston shaft further has a periphery, a thread defined on the periphery;
two sidewalls of the fifth pivotal block each having an eighth through hole that aligns with the fourth through hole on the third pivotal block to allow the second pivotal shaft penetrating therethrough and engaging the second screw;
the fifth pivotal block further has a threaded hole defined in a middle section between the two sidewalls on the fifth pivotal block to engage the thread on the periphery of the piston shaft.
